(19) United States
(12) Patent Application Publication
(10) Pub. No.: US 2020/0210176 A1
(43) Pub. Date: Jul. 2, 2020

(54) SYSTEMS AND METHODS FOR COMPONENT FAULT DETECTION

(71) Applicant: Lyft, Inc., San Francisco, CA (US)

(72) Inventors: David Wu, Mountain View, CA (US); Seyed Mahmoudreza Saadat, Redwood City, CA (US)

(73) Assignee: Lyft, Inc., San Francisco, CA (US)

(21) Appl. No.: 16/237,177

(22) Filed: Dec. 31, 2018

(51) Int. Cl. G06F 9/30; G06F 1/3225

(52) U.S. Cl. CPC G06F 9/3004; G06F 1/3225

(57) ABSTRACT

Systems, methods, and non-transitory computer-readable media can receive power consumption information for a component in a vehicle indicative of power consumption by the component. The power consumption information is compared with a nominal power signature associated with the component. A determination is made that power consumption of the component deviates from the nominal power signature. Corrective action is executed based on the determining that power consumption of the component deviates from the nominal power signature.

### FIELD OF THE INVENTION

The present technology relates to vehicle systems. More particularly, the present technology relates to systems, apparatus, and methods for detecting faulty components in vehicle systems.

### BACKGROUND

Vehicles are increasingly being equipped with intelligent features that allow them to monitor their surroundings and make informed decisions on how to react. Such vehicles, whether autonomously, semi-autonomously, or manually driven, may be capable of sensing their environment and navigating with little or no human input as appropriate. The vehicle may include a variety of systems and subsystems for enabling the vehicle to determine its surroundings so that it may safely navigate to target destinations or assist a human driver, if one is present, with doing the same. As one example, the vehicle may have a computing system (e.g., one or more central processing units, graphical processing units, memory, storage, etc.) for controlling various operations of the vehicle, such as driving and navigating. To that end, the computing system may process data from one or more sensors. For example, a vehicle may have sensors that can recognize hazards, roads, lane markings, traffic signals, and the like. Data from sensors may be used to, for example, safely drive the vehicle, activate certain safety features (e.g., automatic braking), and generate alerts about potential hazards.

### SUMMARY

Various embodiments of the present technology can include systems, methods, and non-transitory computer readable media configured to receive power consumption information for a component in a vehicle indicative of power consumption by the component. The power consumption information is compared with a nominal power signature associated with the component. A determination is made that power consumption of the component deviates from the nominal power signature. Corrective action is executed based on the determining that power consumption of the component deviates from the nominal power signature.

In an embodiment, it is determined that communications with the component have not been lost. A determination is made that failure of the component is impending based on the determination that power consumption of the component deviates from the nominal power signature and the determination that communications with the component have not been lost.

In an embodiment, the executing corrective action comprises generating a notification requesting preventative maintenance for the component.

In an embodiment, a determination is made that communications with the component have been lost. A determination is made that the component has failed based on the determination that power consumption of the component deviates from the nominal power signature and the determination that communications with the component have been lost.

In an embodiment, the component is a sensor on the vehicle.

In an embodiment, the executing corrective action comprises causing information from the sensor to be disregarded based on the determination that the sensor has failed.

In an embodiment, power consumption information is received for a second component in the vehicle. The power consumption information is indicative of power consumption by the second component. The power consumption information for the second component is compared with a second nominal power signature associated with the second component. A determination is made that power consumption of the second component does not deviate from the second nominal power signature.

In an embodiment, a determination is made that communications with the second component have been lost. A determination is made that a communications system on the vehicle has a fault based on the determination that power consumption of the second component does not deviate from the second nominal power signature and the determination that communications with the second component have been lost.

In an embodiment, the component is associated with a plurality of nominal power signatures, and each nominal power signature of the plurality of nominal power signatures is associated with a respective operating state of the component.

In an embodiment, comparing the power consumption information with a nominal power signature associated with the component comprises comparing the power consumption information with a first nominal power signature of the plurality of nominal power signatures, wherein the first nominal power signature is selected from the plurality of nominal power signatures based on a current operating state of the component. Determining that power consumption of the component deviates from the nominal power signature comprises determining that power consumption of the component deviates from the first nominal power signature.

It should be appreciated that many other features, applications, embodiments, and variations of the disclosed technology will be apparent from the accompanying drawings and from the following detailed description. Additional and alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example scenario demonstrating various challenges that may be experienced in conventional approaches to vehicle operation.

FIG. 2 illustrates an example smart monitoring module, according to an embodiment of the present technology.

FIG. 3 illustrates an example functional block diagram, according to an embodiment of the present technology.

FIGS. 4A-C illustrate example power consumption curves, according to various embodiments of the present technology.

FIG. 5 illustrates an example method, according to an embodiment of the present technology.

FIG. 6 illustrates an example block diagram of a transportation management environment, according to an embodiment of the present technology.

FIG. 7 illustrates an example of a computer system or computing device that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

Vehicles are increasingly being equipped with intelligent features that allow them to monitor their surroundings and make informed decisions on how to react. Such vehicles, whether autonomously, semi-autonomously, or manually driven, may be capable of sensing their environment and navigating with little or no human input. The vehicle may include a variety of systems and subsystems for enabling the vehicle to determine its surroundings so that it may safely navigate to target destinations or assist a human driver, if one is present, with doing the same. As one example, the vehicle may have a computing system for controlling various operations of the vehicle, such as driving and navigating. To that end, the computing system may process data from one or more sensors. For example, a vehicle may have one or more sensors or sensor systems that can recognize hazards, roads, lane markings, traffic signals, etc. Data from sensors may be used to, for example, safely drive the vehicle, activate certain safety features (e.g., automatic braking), and generate alerts about potential hazards.

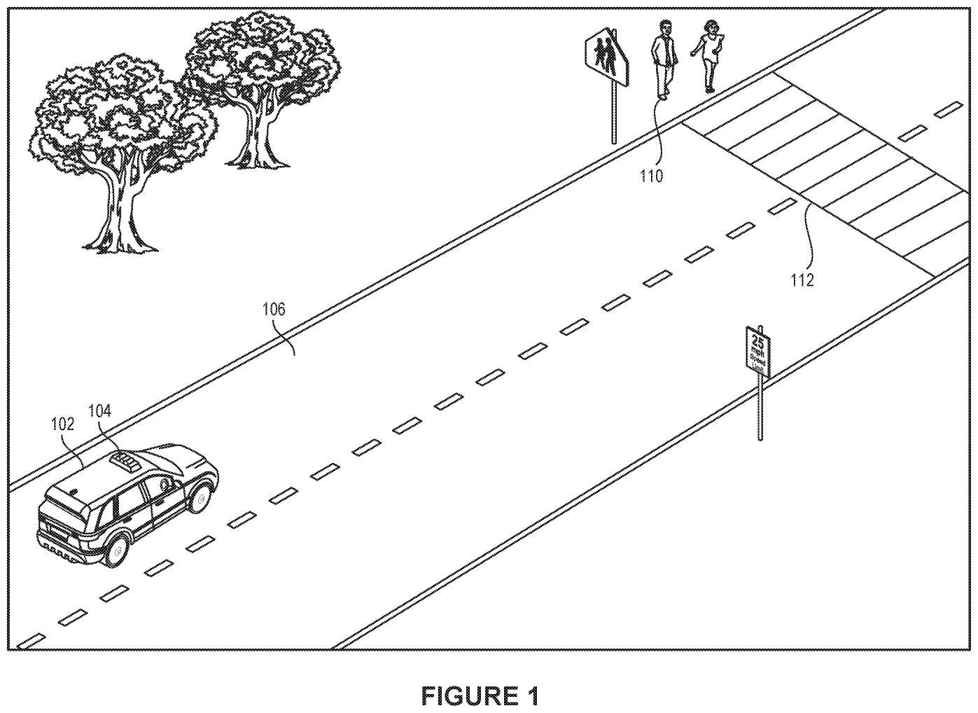

In the context of autonomous, semi-autonomous, and manually-driven vehicles, it is important to have accurate information pertaining to vehicle operation. For example, it is important to quickly and accurately identify any components within the vehicle that may not be operating correctly. FIG. 1 illustrates an example scenario that is illustrative of various challenges that may be experienced using conventional approaches. In FIG. 1, a vehicle 102 includes a sensor suite 104 and is driving down a road 106. The vehicle 102 may be an autonomous, semi-autonomous, or manually-driven vehicle. The sensor suite 104 may include various sensors that the vehicle 102 relies upon to safely operate the vehicle. For example, the sensor suite 104 may include one or more lidar systems, one or more radar systems, one or more cameras, one or more microphones, one or more ultrasound equipment systems, and the like. The vehicle 102 may rely on inputs from each sensor to safely operate. As such, it is important to be able to determine whether or not each sensor is operating correctly. For example, the vehicle 102 may, using one or more sensors in the sensor suite 104, detect the presence of pedestrians 110 about to cross a crosswalk 112. In order to come to a complete stop just before the crosswalk 112, the vehicle 102 must receive accurate information from the sensors about the precise position of the crosswalk 112 and the pedestrians 110 with respect to the vehicle 102. A faulty sensor or other faulty components on the vehicle 102 may result in inaccurate information and potentially unsafe operation of the vehicle 102. Similarly, in order to successfully navigate the road 106, the vehicle must know its position relative to lane markings. If the vehicle 102 does not receive accurate information relating to the position of the vehicle 102 within its environment from the sensors in the sensor suite 104, decisions made by a computing system of the vehicle 102 may be premised on incorrect assumptions, and could result in suboptimal vehicle operation and potentially pose safety hazards.

A vehicle, such as the vehicle 102, includes numerous components that are needed for optimal vehicle operation including, but not limited to, various sensors, lights, steering systems, navigation systems, speakers, and other electronic components. Under conventional approaches, it may be very difficult, if not impossible, to predict when components may fail. As such, under conventional approaches, users may unknowingly be operating vehicles that are about to fail. This represents, at best, a significant inconvenience, as users must scramble to repair a vehicle after it has already failed, or at worst a safety hazard. Lack of information about impending component failures represents an even greater consideration for a fleet of vehicles providing transportation services. Lack of information about impending component failures can lead to poor rider experience, delays for ordering parts and repairing vehicles when component failures occur, and/or safety-related issues.

Under conventional approaches, certain components in a vehicle, such as one or more sensors on the vehicle, may include built-in diagnostics to determine whether or not the component is operating correctly. Individual components can communicate with a computing system on the vehicle using a communications system on the vehicle (e.g., a controller area network, ethernet connections, one or more network switches). The computing system can communicate with the components over the communications system to conduct checks on whether these components are operating as expected. However, communications systems on vehicles may also experience failure, for example, due to bad wiring or broken connections. As such, under conventional approaches, even if a fault is detected, it may be difficult to determine whether a particular component has failed or if the communications system has failed. Additionally, given the importance of quickly and accurately identifying faulty components, redundancy in relation to fault detection would support safe vehicle operation. However, such redundancy generally is not available today. Furthermore, while certain components do have built-in diagnostics and the ability to exchange two-way communications with a computing system, not all components have such capabilities. For these components, conventional approaches may not have the ability to quickly identify or detect component failures. Conventional approaches thus pose significant disadvantages.

An improved approach in accordance with the present technology overcomes the foregoing and other disadvantages associated with conventional approaches. In relation to the present technology, a power monitoring system can be employed to monitor and record power consumption (e.g., current and voltage) for individual components (or devices) within a vehicle. Each component can be characterized under nominal operating conditions to determine a nominal power signature for the component. In a fault situation, the power draw of a component may deviate from its nominal power signature (e.g., increased or decreased power draw, a loss of characteristic power spikes, presence of unusual spikes in power, etc.). By utilizing data from the power monitoring system and identifying components that are deviating from their nominal power signatures, faulty components can be identified. In certain embodiments, in addition to component power draw information, vehicle communications system information can be utilized to provide further information on potential component failures. For example, vehicle communications system information may indicate whether communications with a particular component have been lost. Severed communications with a component may indicate component failure, or may be caused by a problem in the communications system. Combining component power draw information with vehicle communications system information may be useful in distinguishing between failures in individual components and failures in the communications system. More details relating to the present technology are provided below.

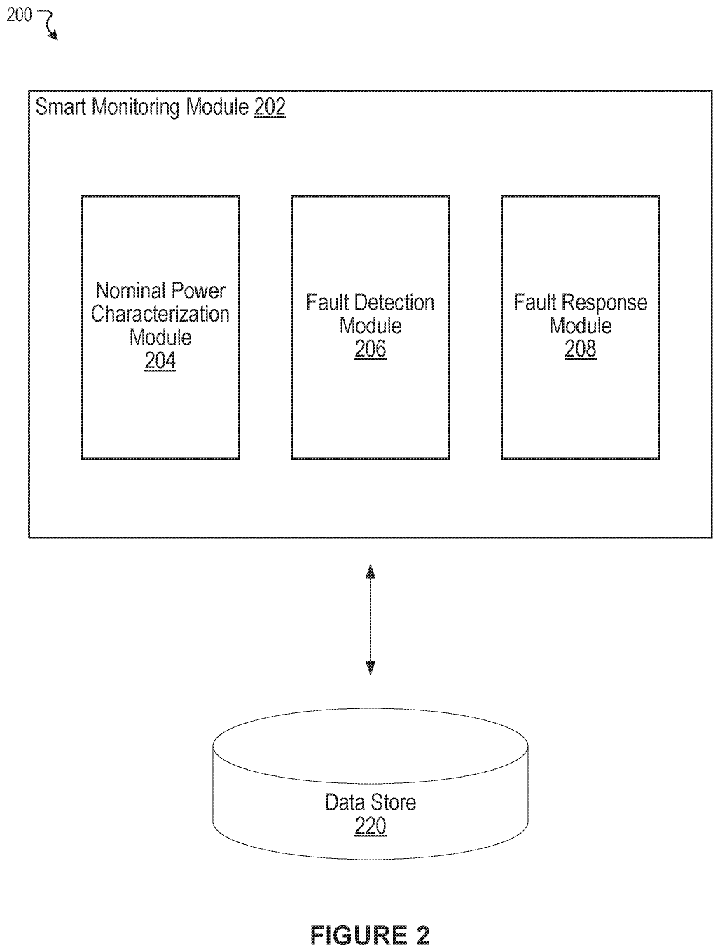

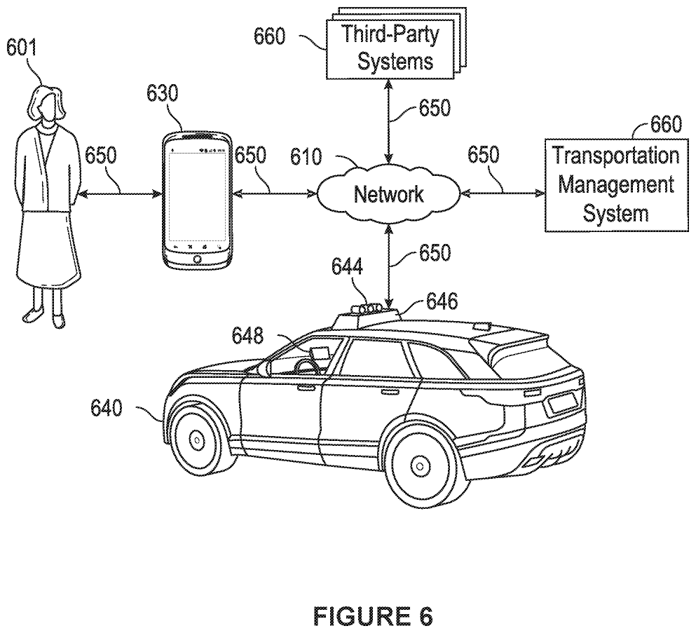

FIG. 2 illustrates an example system 200 including an example smart monitoring module 202, according to an embodiment of the present technology. As shown in the example of FIG. 2, the smart monitoring module 202 can include a nominal power characterization module 204, a fault detection module 206, and a fault response module 208. In some instances, the example system 200 can include at least one data store 220. In some embodiments, some or all of the functionality performed by the smart monitoring module 202 and its sub-modules may be performed by one or more backend computing systems, such as a transportation management system 660 of FIG. 6. In some embodiments, some or all of the functionality performed by the smart monitoring module 202 and its sub-modules may be performed by one or more computing systems implemented in a vehicle, such as a vehicle 640 of FIG. 6. The components (e.g., modules, elements, etc.) shown in this figure and all figures herein are exemplary only, and other implementations may include additional, fewer, integrated, or different components. Some components may not be shown so as not to obscure relevant details.

The smart monitoring module 202 can be configured to communicate and operate with the at least one data store 220, as shown in the example system 200. The at least one data store 220 can be configured to store and maintain various types of data. For example, the data store 220 can store nominal power signatures for various components in a vehicle, current and voltage readings of various components in a vehicle, and the like. In some embodiments, some or all data stored in the data store 220 can be stored by the transportation management system 660 of FIG. 6. In some embodiments, some or all data stored in the data store 220 can be stored by the vehicle 640 of FIG. 6. More details about information that can be stored in the data store 220 are provided below.

The nominal power characterization module 204 can be configured to generate and maintain one or more nominal power signatures for a device (i.e., a component). For example, the nominal power characterization module 204 can generate and maintain one or more nominal power signatures for a component of a vehicle. For a given component, the nominal power characterization module 204 can monitor the component's power consumption during normal operation. Information pertaining to the component's power consumption during normal operation can be stored as a nominal power signature for that component. A nominal power signature can include any power consumption information that may be useful for characterizing a component's typical or expected power consumption and identifying deviations from the component's normal power consumption behavior. For example, such power consumption information can include power consumption by the component over a period of time, a range of nominal power consumption values, a range of nominal power consumption frequencies (e.g., for periodic power consumption curves), a moving average of power consumption values or frequencies, and the like. In certain instances, a component may be associated with one nominal power signature. In other instances, a component may be associated with multiple nominal power signatures. For example, a component may have different power consumption characteristics when it is in an idle state and when it is in an active state, or different power consumption characteristics for different active states. In such instances, the nominal power characterization module 204 may maintain multiple nominal power signatures for a component, with each nominal power signature being associated with a particular operating state for the component (e.g., an idle state, a first active state, a second active state, etc.).

The fault detection module 206 can be configured to monitor component and/or device power consumption and identify potential faults based on power consumption information. As discussed above, each component may be associated with one or more nominal power signatures indicative of normal or expected power consumption by the component. The fault detection module 206 can be configured to monitor a component's power consumption and determine whether or not the component's power consumption deviates from the component's nominal power signature. For example, as discussed above, a component's nominal power signature may define a range of expected power consumption values for a component. In a more particular example, a particular component, such as a sensor, may be expected to draw between 20-40 W of power at any given time. If a component exceeds or falls below a threshold power consumption value (e.g., exceeds an upper threshold value and/or falls below a lower threshold value), the fault detection module 206 can determine that a fault may have occurred. As discussed above, a particular component may have multiple nominal power signatures. In certain instances, the fault detection module 206 can be configured to identify an appropriate nominal power signature from a plurality of nominal power signatures for a component based on current operating conditions. For example, each nominal power signature may be associated with a particular operating state for the component (e.g., an idle state or an active state), and the fault detection module 206 can determine a current operating state of the component to determine the appropriate nominal power signature against which to compare the power consumption of the component.

In certain embodiments, a component's nominal power signature may include both a magnitude component and a frequency component. In such instances, the fault detection module 206 can determine deviations from the nominal power signature based on deviations in magnitude and/or deviations in frequency. In certain instances, a component's power consumption may be very periodic and regular, and, thus, more predictable. For example, a lidar system or a radar system may have a very regular power consumption signature with a well-defined magnitude range and a well-defined frequency range. However, other components may have more irregular power consumption attributes. For example, a computer's power consumption may vary unpredictably depending on the task-load for the computer. In such instances, additional input signals can be used for the fault detection module 206 to determine what should be the expected power draw for a component in a given moment. For example, for a computer, power consumption may be correlated with CPU usage, such that higher CPU usage will generally require greater power consumption. The fault detection module 206 can be configured to receive CPU usage information for a computer, and can determine an expected range of power consumption values based on the CPU usage in a given moment in order to determine whether the computer's power consumption is in line with or deviates from expected values. In certain embodiments, a machine learning model can be trained to receive input signals and determine whether or not a component's power consumption deviates from expected or nominal power consumption as indicated by the component's nominal power signature.

In certain embodiments, the fault detection module 206 can also utilize communications system information to identify potential component faults. As described in greater detail herein, components in a vehicle may communicate with one another using a communications system. For example, one or more sensors on the vehicle may transmit sensor data to a computing system in the vehicle via the communications system. If communications with a particular component are lost or disrupted, this may indicate a component failure.

As mentioned above, interrupted communications with a component may be the result of a faulty component, or may be due to faults in the communications system. In certain embodiments, the fault detection module 206 can be configured to combine power consumption information and communications system information to make determinations about which device or system is at fault in a networked system. An example implementation is reflected in the following state table:

| | | Power | |
|---|---|---|---|
| | Communications | Consumption | Error state |
| Component 1 | OK | nominal | — |
| Component 2 | lost communication | low/high | component failure |
| | | power draw | |
| Component 3 | lost communication | nominal | upstream failure in |
| | | | communications |
| | | | system |
| Component 4 | OK | high power | impending |
| | | draw | component failure |

In the state table above, communications with component 1 are being exchanged normally, and its power consumption falls within prescribed thresholds described by the component's nominal power signature. As such, component 1 is determined to be operating normally. For component 2, communications with the component have been lost, and the component's power consumption is not within prescribed thresholds described by the component's nominal power signature. In this instance, the component has both abnormal communications and abnormal power consumption. As such, the fault detection module 206 can determine that the component has failed or is faulty. For component 3, communications with the component have been lost, but the component's power consumption is normal. The component's normal power consumption may indicate that the component is actually operating normally. As such, the loss in communications may indicate a failure in the communications system rather than the component itself. For component 4, communications with the component are operating normally, but the component's power consumption is determined to be higher than normal. This may indicate that the component is currently operating, but failure may be impending. In one example, this may occur if a LIDAR bearing begins to degrade, causing higher friction, which takes more power to operate. In such cases (or similar scenarios), the component may still be operating, but the high power draw may indicate an impending failure. As can be seen from this example state table, power consumption information and communications system information can be considered jointly to identify potential faults in a networked system (e.g., within a vehicle), and to determine whether the fault is occurring in a particular component or whether the fault is occurring in a communications system.

The fault response module 208 can be configured to take and/or execute a particular corrective action when a fault is detected. Different faults may result in different corrective actions being executed by the fault response module 208. For example, if it is determined that a particular sensor has failed, the fault response module 208 can cause sensor data from that sensor to be disregarded or de-emphasized during operation of a vehicle. Or, if it is determined that a component that is critical to safe operation of the vehicle has failed, the fault response module 208 can cause the vehicle to shut down or stop. In another example, if it is determined that a component is currently operating but an impending failure is detected, the fault response module 208 can generate a notification that requests preventative maintenance to prevent serious faults before they occur. In yet another example, if it is determined that a vehicle communications system is faulty, the fault response module 208 may generate a notification indicating that there may be a broken connection or a faulty communications hub in the communications system. Many variations are possible.

In certain embodiments, in response to a determination that a component in a vehicle is faulty or may soon fail, the fault response module 208 can be configured not only to execute corrective action with respect to the particular vehicle, but also to execute corrective action to optimize operations for a fleet of vehicles. For example, if it is determined that a first vehicle in a fleet of vehicles has a faulty component or a component that may soon fail, the fault response module 208 can report this information to a transportation management system (such as the transportation management system 660 of FIG. 6) so that appropriate action can be taken. In certain embodiments, the fault response module 208 and/or the transportation management system may cause another vehicle in the fleet of vehicles to be assigned to transport one or more riders in place of the first vehicle. In certain embodiments, the fault response module 208 and/or the transportation management system may cause the first vehicle to navigate to a repair station, or may cause a repair vehicle to navigate to the first vehicle in order to repair and/or retrieve the first vehicle. In another example, if it is determined that a component has not yet failed, but may fail soon, the fault response module 208 may cause a replacement component to be ordered so that the component can be replaced before it fails. Again, many variations are possible.

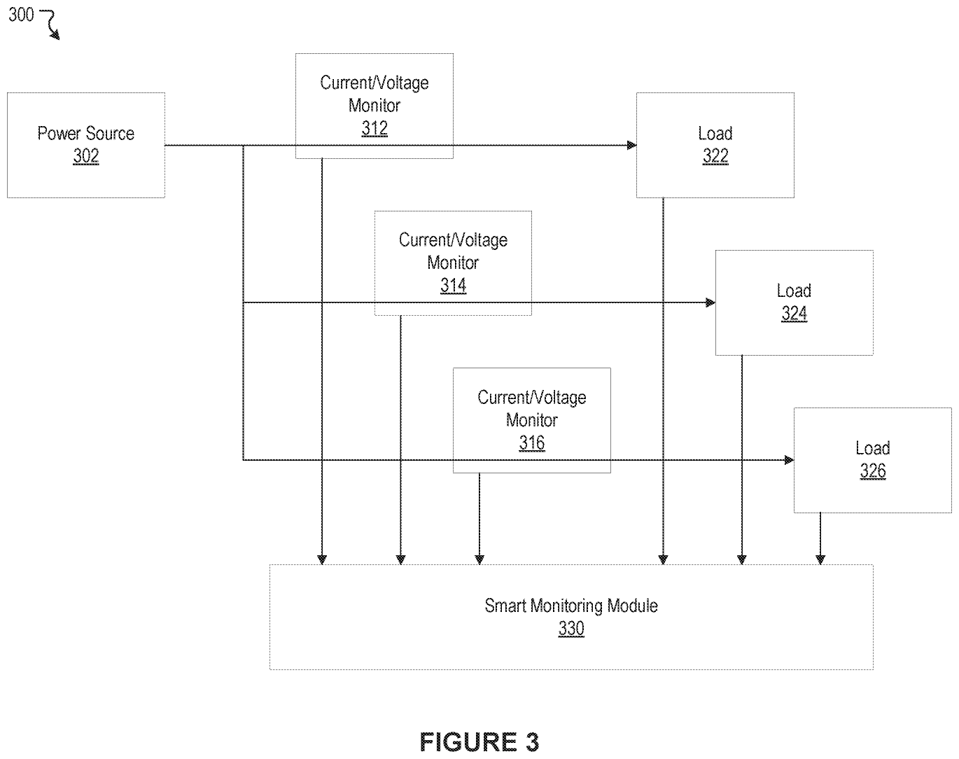

FIG. 3 illustrates an example functional block diagram 300 to illustrate various aspects of the present technology. The functional block diagram 300 includes a power source 302. The power source 302 may be, for example, a power source in a vehicle (e.g., a battery in the vehicle). The power source 302 provides power to three loads 322, 324, 326. The three loads 322, 324, 326 may be components in a vehicle. For example, the loads may be various sensors in the vehicle. The power to each load 322, 324, 326 is monitored by a respective current/voltage monitor 312, 314, 316. Each current/voltage monitor 312, 314, 316 can report power consumption information for each load 322, 324, 326 to a smart monitoring module 330. The smart monitoring module 330 may be implemented, for example, as the smart monitoring module 202 of FIG. 2. The smart monitoring module 330 can take current power consumption by the loads 322, 324, 326 and compare them to nominal power signatures to determine whether the power consumption for each load is within an expected range. If power consumption for a load is outside of expected values, the smart monitoring module 330 can determine that there may be a present or impending fault in the load. Each load 322, 324, 326 may also be in communication with the smart monitoring module 330, for example, over a communications system within a vehicle (e.g., a controller area network). The smart monitoring module 330 can use communications system information in conjunction with power consumption information to identify potential faults within the vehicle, and to distinguish between faults in a particular component (or load) and faults in the communications system. In certain embodiments, if it is determined that multiple components are faulty, a combination of faulty components may be used to determine a larger underlying problem in the vehicle, or to predict imminent or impending failure of another component that is still operational.

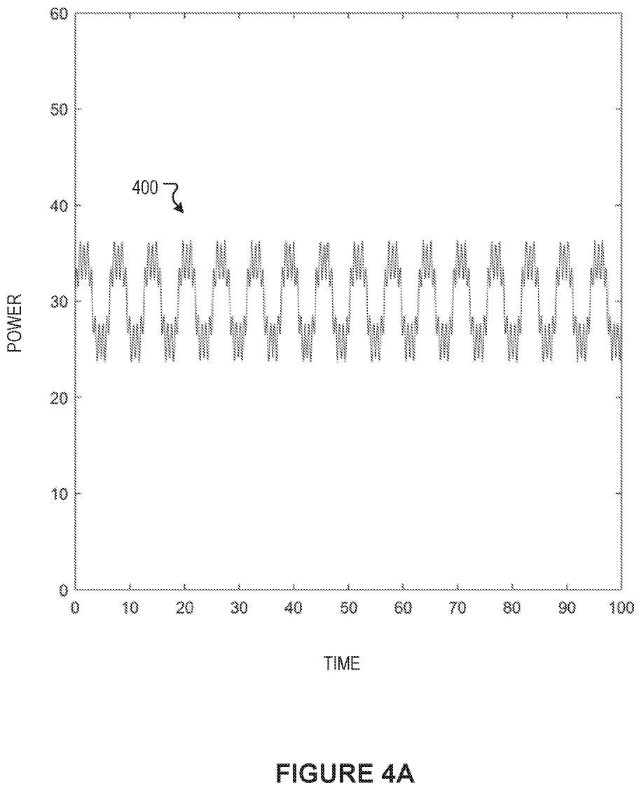

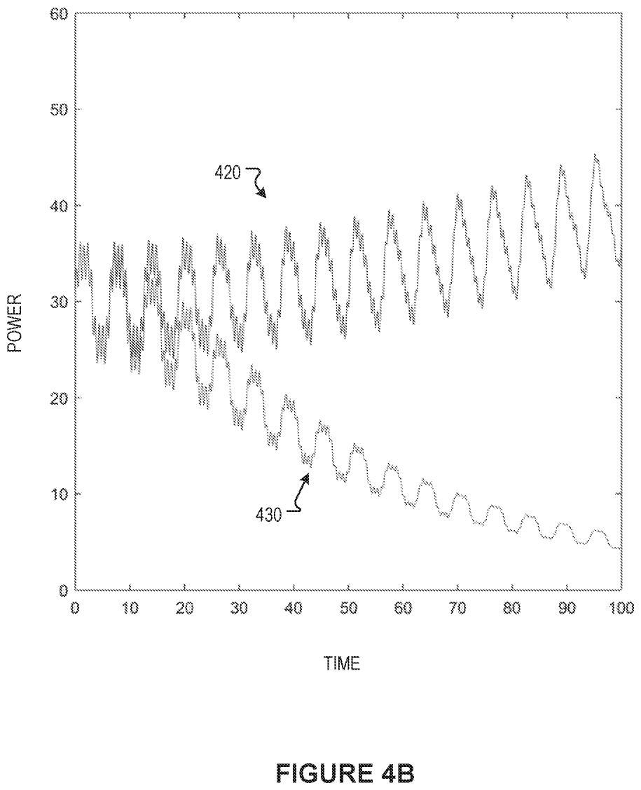

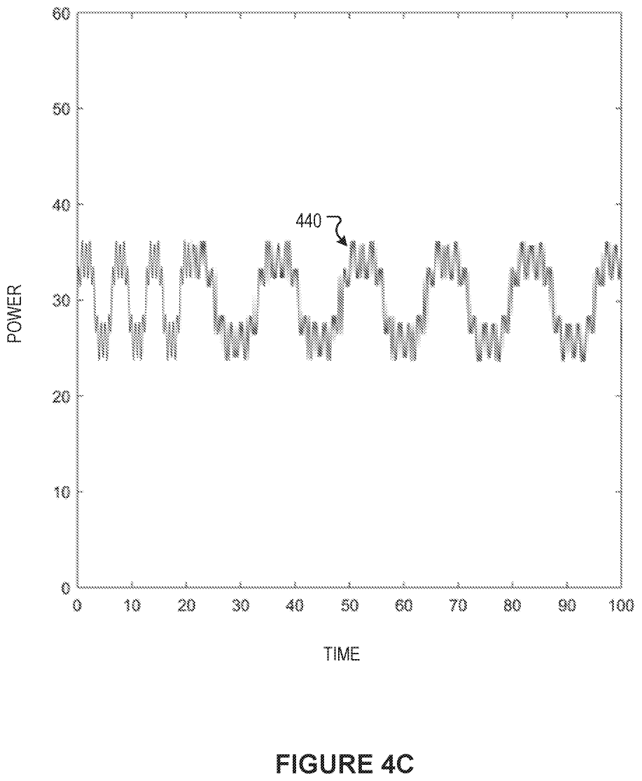

FIGS. 4A, 4B, and 4C illustrate example power consumption curves. FIG. 4A illustrates an example nominal power signature 400 for a component. It can be seen that in the example nominal power signature 400, the component's power consumption can be expected to remain between 25-35 W, and can be expected to reflect a regular frequency. In FIG. 4B, two example power consumption curves 420, 430 are shown which deviate from the nominal power signature 400. The power consumption curve 420 shows component power consumption that is gradually exceeding the expected power consumption range of 25-35 W. The power consumption curve 430 shows component power consumption that is gradually falling below the expected power consumption range of 25-35 W. In FIG. 4C, an example power consumption curve 440 is shown which deviates from the nominal power signature 400. In the power consumption curve 440, the frequency of the power consumption curve begins to deviate from the expected frequency shown in the nominal power signature 400. In any of these scenarios, a determination can be made that the component's power consumption is deviating from the nominal power signature of the component, and that the component may be faulty or may imminently fail.

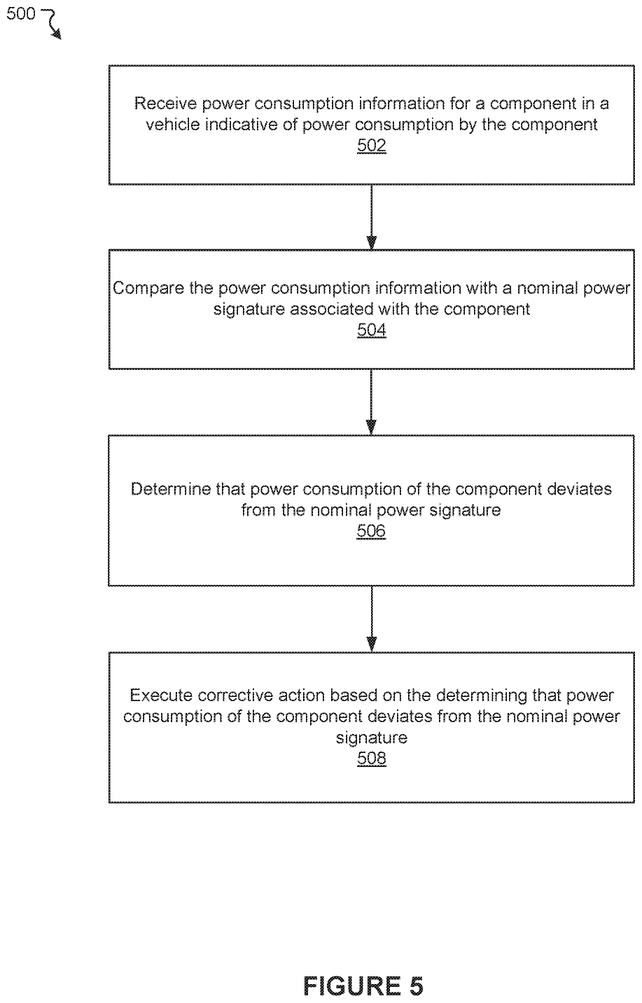

FIG. 5 illustrates an example method 500, according to an embodiment of the present technology. At block 502, the example method 500 can receive power consumption information for a component in a vehicle indicative of power consumption by the component. At block 504, the example method 500 can compare the power consumption information with a nominal power signature associated with the component. At block 506, the example method 500 can determine that power consumption of the component deviates from the nominal power signature. At block 508, the example method 500 can execute corrective action based on the determining that power consumption of the component deviates from the nominal power signature.

Many variations to the example method are possible. It should be appreciated that there can be additional, fewer, or alternative steps performed in similar or alternative orders, or in parallel, within the scope of the various embodiments discussed herein unless otherwise stated.

FIG. 6 illustrates an example block diagram of a transportation management environment for matching ride requestors with vehicles. In particular embodiments, the environment may include various computing entities, such as a user computing device 630 of a user 601 (e.g., a ride provider or requestor), a transportation management system 660, a vehicle 640, and one or more third-party systems 670. The vehicle 640 can be autonomous, semi-autonomous, or manually drivable. The computing entities may be communicatively connected over any suitable network 610. As an example and not by way of limitation, one or more portions of network 610 may include an ad hoc network, an extranet, a virtual private network (VPN), a local area network (LAN), a wireless LAN (WLAN), a wide area network (WAN), a wireless WAN (WWAN), a metropolitan area network (MAN), a portion of the Internet, a portion of Public Switched Telephone Network (PSTN), a cellular network, or a combination of any of the above. In particular embodiments, any suitable network arrangement and protocol enabling the computing entities to communicate with each other may be used. Although FIG. 6 illustrates a single user device 630, a single transportation management system 660, a single vehicle 640, a plurality of third-party systems 670, and a single network 610, this disclosure contemplates any suitable number of each of these entities. As an example and not by way of limitation, the network environment may include multiple users 601, user devices 630, transportation management systems 660, vehicles 640, third-party systems 670, and networks 610. In some embodiments, some or all modules of the smart monitoring module 202 may be implemented by one or more computing systems of the transportation management system 660. In some embodiments, some or all modules of the smart monitoring module 202 may be implemented by one or more computing systems in the vehicle 640.

The user device 630, transportation management system 660, vehicle 640, and third-party system 670 may be communicatively connected or co-located with each other in whole or in part. These computing entities may communicate via different transmission technologies and network types. For example, the user device 630 and the vehicle 640 may communicate with each other via a cable or short-range wireless communication (e.g., Bluetooth, NFC, WI-FI, etc.), and together they may be connected to the Internet via a cellular network that is accessible to either one of the devices (e.g., the user device 630 may be a smartphone with LTE connection). The transportation management system 660 and third-party system 670, on the other hand, may be connected to the Internet via their respective LAN/WLAN networks and Internet Service Providers (ISP). FIG. 6 illustrates transmission links 650 that connect user device 630, vehicle 640, transportation management system 660, and third-party system 670 to communication network 610. This disclosure contemplates any suitable transmission links 650, including, e.g., wire connections (e.g., USB, Lightning, Digital Subscriber Line (DSL) or Data Over Cable Service Interface Specification (DOCSIS)), wireless connections (e.g., WI-FI, WiMAX, cellular, satellite, NFC, Bluetooth), optical connections (e.g., Synchronous Optical Networking (SONET), Synchronous Digital Hierarchy (SDH)), any other wireless communication technologies, and any combination thereof. In particular embodiments, one or more links 650 may connect to one or more networks 610, which may include in part, e.g., ad-hoc network, the Intranet, extranet, VPN, LAN, WLAN, WAN, WWAN, MAN, PSTN, a cellular network, a satellite network, or any combination thereof. The computing entities need not necessarily use the same type of transmission link 650. For example, the user device 630 may communicate with the transportation management system via a cellular network and the Internet, but communicate with the vehicle 640 via Bluetooth or a physical wire connection.

In particular embodiments, the transportation management system 660 may fulfill ride requests for one or more users 601 by dispatching suitable vehicles. The transportation management system 660 may receive any number of ride requests from any number of ride requestors 601. In particular embodiments, a ride request from a ride requestor 601 may include an identifier that identifies the ride requestor in the system 660. The transportation management system 660 may use the identifier to access and store the ride requestor's 601 information, in accordance with the requestor's 601 privacy settings. The ride requestor's 601 information may be stored in one or more data stores (e.g., a relational database system) associated with and accessible to the transportation management system 660. In particular embodiments, ride requestor information may include profile information about a particular ride requestor 601. In particular embodiments, the ride requestor 601 may be associated with one or more categories or types, through which the ride requestor 601 may be associated with aggregate information about certain ride requestors of those categories or types. Ride information may include, for example, preferred pick-up and drop-off locations, driving preferences (e.g., safety comfort level, preferred speed, rates of acceleration/deceleration, safety distance from other vehicles when travelling at various speeds, route, etc.), entertainment preferences and settings (e.g., preferred music genre or playlist, audio volume, display brightness, etc.), temperature settings, whether conversation with the driver is welcomed, frequent destinations, historical riding patterns (e.g., time of day of travel, starting and ending locations, etc.), preferred language, age, gender, or any other suitable information. In particular embodiments, the transportation management system 660 may classify a user 601 based on known information about the user 601 (e.g., using machine-learning classifiers), and use the classification to retrieve relevant aggregate information associated with that class. For example, the system 660 may classify a user 601 as a young adult and retrieve relevant aggregate information associated with young adults, such as the type of music generally preferred by young adults.

Transportation management system 660 may also store and access ride information. Ride information may include locations related to the ride, traffic data, route options, optimal pick-up or drop-off locations for the ride, or any other suitable information associated with a ride. As an example and not by way of limitation, when the transportation management system 660 receives a request to travel from San Francisco International Airport (SFO) to Palo Alto, Calif., the system 660 may access or generate any relevant ride information for this particular ride request. The ride information may include, for example, preferred pick-up locations at SFO; alternate pick-up locations in the event that a pick-up location is incompatible with the ride requestor (e.g., the ride requestor may be disabled and cannot access the pick-up location) or the pick-up location is otherwise unavailable due to construction, traffic congestion, changes in pick-up/drop-off rules, or any other reason; one or more routes to navigate from SFO to Palo Alto; preferred off-ramps for a type of user; or any other suitable information associated with the ride. In particular embodiments, portions of the ride information may be based on historical data associated with historical rides facilitated by the system 660. For example, historical data may include aggregate information generated based on past ride information, which may include any ride information described herein and telemetry data collected by sensors in vehicles and user devices. Historical data may be associated with a particular user (e.g., that particular user's preferences, common routes, etc.), a category/class of users (e.g., based on demographics), and all users of the system 660. For example, historical data specific to a single user may include information about past rides that particular user has taken, including the locations at which the user is picked up and dropped off, music the user likes to listen to, traffic information associated with the rides, time of the day the user most often rides, and any other suitable information specific to the user. As another example, historical data associated with a category/class of users may include, e.g., common or popular ride preferences of users in that category/class, such as teenagers preferring pop music, ride requestors who frequently commute to the financial district may prefer to listen to the news, etc. As yet another example, historical data associated with all users may include general usage trends, such as traffic and ride patterns. Using historical data, the system 660 in particular embodiments may predict and provide ride suggestions in response to a ride request. In particular embodiments, the system 660 may use machine-learning, such as neural networks, regression algorithms, instance-based algorithms (e.g., k-Nearest Neighbor), decision-tree algorithms, Bayesian algorithms, clustering algorithms, association-rule-learning algorithms, deep-learning algorithms, dimensionality-reduction algorithms, ensemble algorithms, and any other suitable machine-learning algorithms known to persons of ordinary skill in the art. The machine-learning models may be trained using any suitable training algorithm, including supervised learning based on labeled training data, unsupervised learning based on unlabeled training data, and semi-supervised learning based on a mixture of labeled and unlabeled training data.

In particular embodiments, transportation management system 660 may include one or more server computers. Each server may be a unitary server or a distributed server spanning multiple computers or multiple datacenters. The servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, transportation management system 660 may include one or more data stores. The data stores may be used to store various types of information, such as ride information, ride requestor information, ride provider information, historical information, third-party information, or any other suitable type of information. In particular embodiments, the information stored in the data stores may be organized according to specific data structures. In particular embodiments, each data store may be a relational, columnar, correlation, or any other suitable type of database system. Although this disclosure describes or illustrates particular types of databases, this disclosure contemplates any suitable types of databases. Particular embodiments may provide interfaces that enable a user device 630 (which may belong to a ride requestor or provider), a transportation management system 660, vehicle system 640, or a third-party system 670 to process, transform, manage, retrieve, modify, add, or delete the information stored in the data store.

In particular embodiments, transportation management system 660 may include an authorization server (or any other suitable component(s)) that allows users 601 to opt-in to or opt-out of having their information and actions logged, recorded, or sensed by transportation management system 660 or shared with other systems (e.g., third-party systems 670). In particular embodiments, a user 601 may opt-in or opt-out by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users 601 of transportation management system 660 through blocking, data hashing, anonymization, or other suitable techniques as appropriate.

In particular embodiments, third-party system 670 may be a network-addressable computing system that may provide HD maps or host GPS maps, customer reviews, music or content, weather information, or any other suitable type of information. Third-party system 670 may generate, store, receive, and send relevant data, such as, for example, map data, customer review data from a customer review website, weather data, or any other suitable type of data. Third-party system 670 may be accessed by the other computing entities of the network environment either directly or via network 610. For example, user device 630 may access the third-party system 670 via network 610, or via transportation management system 660. In the latter case, if credentials are required to access the third-party system 670, the user 601 may provide such information to the transportation management system 660, which may serve as a proxy for accessing content from the third-party system 670.

In particular embodiments, user device 630 may be a mobile computing device such as a smartphone, tablet computer, or laptop computer. User device 630 may include one or more processors (e.g., CPU, GPU), memory, and storage. An operating system and applications may be installed on the user device 630, such as, e.g., a transportation application associated with the transportation management system 660, applications associated with third-party systems 670, and applications associated with the operating system. User device 630 may include functionality for determining its location, direction, or orientation, based on integrated sensors such as GPS, compass, gyroscope, or accelerometer. User device 630 may also include wireless transceivers for wireless communication and may support wireless communication protocols such as Bluetooth, near-field communication (NFC), infrared (IR) communication, WI-FI, and 2G/3G/4G/LTE mobile communication standard. User device 630 may also include one or more cameras, scanners, touchscreens, microphones, speakers, and any other suitable input-output devices.

In particular embodiments, the vehicle 640 may be equipped with an array of sensors 644, a navigation system 646, and a ride-service computing device 648. In particular embodiments, a fleet of vehicles 640 may be managed by the transportation management system 660. The fleet of vehicles 640, in whole or in part, may be owned by the entity associated with the transportation management system 660, or they may be owned by a third-party entity relative to the transportation management system 660. In either case, the transportation management system 660 may control the operations of the vehicles 640, including, e.g., dispatching select vehicles 640 to fulfill ride requests, instructing the vehicles 640 to perform select operations (e.g., head to a service center or charging/fueling station, pull over, stop immediately, self-diagnose, lock/unlock compartments, change music station, change temperature, and any other suitable operations), and instructing the vehicles 640 to enter select operation modes (e.g., operate normally, drive at a reduced speed, drive under the command of human operators, and any other suitable operational modes).

In particular embodiments, the vehicles 640 may receive data from and transmit data to the transportation management system 660 and the third-party system 670. Examples of received data may include, e.g., instructions, new software or software updates, maps, 3D models, trained or untrained machine-learning models, location information (e.g., location of the ride requestor, the vehicle 640 itself, other vehicles 640, and target destinations such as service centers), navigation information, traffic information, weather information, entertainment content (e.g., music, video, and news) ride requestor information, ride information, and any other suitable information. Examples of data transmitted from the vehicle 640 may include, e.g., telemetry and sensor data, determinations/decisions based on such data, vehicle condition or state (e.g., battery/fuel level, tire and brake conditions, sensor condition, speed, odometer, etc.), location, navigation data, passenger inputs (e.g., through a user interface in the vehicle 640, passengers may send/receive data to the transportation management system 660 and third-party system 670), and any other suitable data.

In particular embodiments, vehicles 640 may also communicate with each other, including those managed and not managed by the transportation management system 660. For example, one vehicle 640 may communicate with another vehicle data regarding their respective location, condition, status, sensor reading, and any other suitable information. In particular embodiments, vehicle-to-vehicle communication may take place over direct short-range wireless connection (e.g., WI-FI, Bluetooth, NFC) or over a network (e.g., the Internet or via the transportation management system 660 or third-party system 670), or both.

In particular embodiments, a vehicle 640 may obtain and process sensor/telemetry data. Such data may be captured by any suitable sensors. For example, the vehicle 640 may have a Light Detection and Ranging (LiDAR) sensor array of multiple LiDAR transceivers that are configured to rotate 360°, emitting pulsed laser light and measuring the reflected light from objects surrounding vehicle 640. In particular embodiments, LiDAR transmitting signals may be steered by use of a gated light valve, which may be a MEMs device that directs a light beam using the principle of light diffraction. Such a device may not use a gimbaled mirror to steer light beams in 360° around the vehicle. Rather, the gated light valve may direct the light beam into one of several optical fibers, which may be arranged such that the light beam may be directed to many discrete positions around the vehicle. Thus, data may be captured in 360° around the vehicle, but no rotating parts may be necessary. A LiDAR is an effective sensor for measuring distances to targets, and as such may be used to generate a three-dimensional (3D) model of the external environment of the vehicle 640. As an example and not by way of limitation, the 3D model may represent the external environment including objects such as other cars, curbs, debris, objects, and pedestrians up to a maximum range of the sensor arrangement (e.g., 50, 100, or 200 meters). As another example, the vehicle 640 may have optical cameras pointing in different directions. The cameras may be used for, e.g., recognizing roads, lane markings, street signs, traffic lights, police, other vehicles, and any other visible objects of interest. To enable the vehicle 640 to “see” at night, infrared cameras may be installed. In particular embodiments, the vehicle may be equipped with stereo vision for, e.g., spotting hazards such as pedestrians or tree branches on the road. As another example, the vehicle 640 may have radars for, e.g., detecting other vehicles and hazards afar. Furthermore, the vehicle 640 may have ultrasound equipment for, e.g., parking and obstacle detection. In addition to sensors enabling the vehicle 640 to detect, measure, and understand the external world around it, the vehicle 640 may further be equipped with sensors for detecting and self-diagnosing the vehicle's own state and condition. For example, the vehicle 640 may have wheel sensors for, e.g., measuring velocity; global positioning system (GPS) for, e.g., determining the vehicle's current geolocation; and inertial measurement units, accelerometers, gyroscopes, and odometer systems for movement or motion detection. While the description of these sensors provides particular examples of utility, one of ordinary skill in the art would appreciate that the utilities of the sensors are not limited to those examples. Further, while an example of a utility may be described with respect to a particular type of sensor, it should be appreciated that the utility may be achieved using any combination of sensors. For example, the vehicle 640 may build a 3D model of its surrounding based on data from its LiDAR, radar, sonar, and cameras, along with a pre-generated map obtained from the transportation management system 660 or the third-party system 670. Although sensors 644 appear in a particular location on the vehicle 640 in FIG. 6, sensors 644 may be located in any suitable location in or on the vehicle 640. Example locations for sensors include the front and rear bumpers, the doors, the front windshield, on the side panel, or any other suitable location.

In particular embodiments, the vehicle 640 may be equipped with a processing unit (e.g., one or more CPUs and GPUs), memory, and storage. The vehicle 640 may thus be equipped to perform a variety of computational and processing tasks, including processing the sensor data, extracting useful information, and operating accordingly. For example, based on images captured by its cameras and a machine-vision model, the vehicle 640 may identify particular types of objects captured by the images, such as pedestrians, other vehicles, lanes, curbs, and any other objects of interest.

In particular embodiments, the vehicle 640 may have a navigation system 646 responsible for safely navigating the vehicle 640. In particular embodiments, the navigation system 646 may take as input any type of sensor data from, e.g., a Global Positioning System (GPS) module, inertial measurement unit (IMU), LiDAR sensors, optical cameras, radio frequency (RF) transceivers, or any other suitable telemetry or sensory mechanisms. The navigation system 646 may also utilize, e.g., map data, traffic data, accident reports, weather reports, instructions, target destinations, and any other suitable information to determine navigation routes and particular driving operations (e.g., slowing down, speeding up, stopping, swerving, etc.). In particular embodiments, the navigation system 646 may use its determinations to control the vehicle 640 to operate in prescribed manners and to guide the vehicle 640 to its destinations without colliding into other objects. Although the physical embodiment of the navigation system 646 (e.g., the processing unit) appears in a particular location on the vehicle 640 in FIG. 6, navigation system 646 may be located in any suitable location in or on the vehicle 640. Example locations for navigation system 646 include inside the cabin or passenger compartment of the vehicle 640, near the engine/battery, near the front seats, rear seats, or in any other suitable location.

In particular embodiments, the vehicle 640 may be equipped with a ride-service computing device 648, which may be a tablet or any other suitable device installed by transportation management system 660 to allow the user to interact with the vehicle 640, transportation management system 660, other users 601, or third-party systems 670. In particular embodiments, installation of ride-service computing device 648 may be accomplished by placing the ride-service computing device 648 inside the vehicle 640, and configuring it to communicate with the vehicle 640 via a wired or wireless connection (e.g., via Bluetooth). Although FIG. 6 illustrates a single ride-service computing device 648 at a particular location in the vehicle 640, the vehicle 640 may include several ride-service computing devices 648 in several different locations within the vehicle. As an example and not by way of limitation, the vehicle 640 may include four ride-service computing devices 648 located in the following places: one in front of the front-left passenger seat (e.g., driver's seat in traditional U.S. automobiles), one in front of the front-right passenger seat, one in front of each of the rear-left and rear-right passenger seats. In particular embodiments, ride-service computing device 648 may be detachable from any component of the vehicle 640. This may allow users to handle ride-service computing device 648 in a manner consistent with other tablet computing devices. As an example and not by way of limitation, a user may move ride-service computing device 648 to any location in the cabin or passenger compartment of the vehicle 640, may hold ride-service computing device 648, or handle ride-service computing device 648 in any other suitable manner. Although this disclosure describes providing a particular computing device in a particular manner, this disclosure contemplates providing any suitable computing device in any suitable manner.

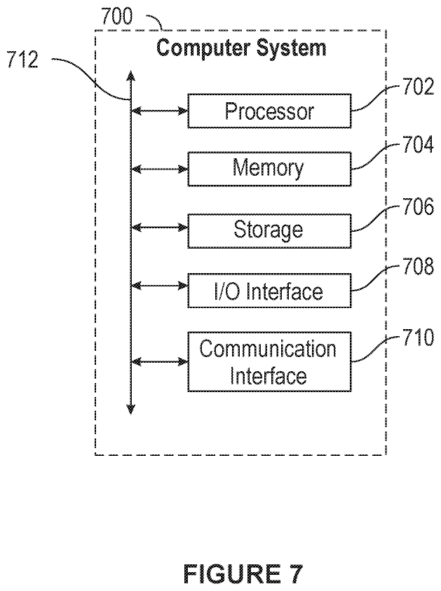

FIG. 7 illustrates an example computer system 700. In particular embodiments, one or more computer systems 700 perform one or more steps of one or more methods described or illustrated herein. In particular embodiments, one or more computer systems 700 provide the functionalities described or illustrated herein. In particular embodiments, software running on one or more computer systems 700 performs one or more steps of one or more methods described or illustrated herein or provides the functionalities described or illustrated herein. Particular embodiments include one or more portions of one or more computer systems 700. Herein, a reference to a computer system may encompass a computing device, and vice versa, where appropriate. Moreover, a reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 that are to be operated on by computer instructions; the results of previous instructions executed by processor 702 that are accessible to subsequent instructions or for writing to memory 704 or storage 706; or any other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs), be a multi-core processor, or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described in further detail below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware or software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware or software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or any other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a Bluetooth WPAN), a WI-FI network, a WI-MAX network, a cellular telephone network (such as, for example, a Global System for Mobile Communications (GSM) network), or any other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware or software, or both coupling components of computer system 700 to each other. As an example and not by way of limitation, bus 712 may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A or B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Methods described herein may vary in accordance with the present disclosure. Various embodiments of this disclosure may repeat one or more steps of the methods described herein, where appropriate. Although this disclosure describes and illustrates particular steps of certain methods as occurring in a particular order, this disclosure contemplates any suitable steps of the methods occurring in any suitable order or in any combination which may include all, some, or none of the steps of the methods. Furthermore, although this disclosure may describe and illustrate particular components, devices, or systems carrying out particular steps of a method, this disclosure contemplates any suitable combination of any suitable components, devices, or systems carrying out any suitable steps of the method.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, modules, elements, feature, functions, operations, or steps, any of these embodiments may include any combination or permutation of any of the components, modules, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A computer-implemented method comprising:
receiving, by a computing system, power consumption information for a component in a vehicle indicative of power consumption by the component;
comparing, by the computing system, the power consumption information with a nominal power signature associated with the component;
determining, by the computing system, that power consumption of the component deviates from the nominal power signature; and
executing, by the computing system, corrective action based on the determining that power consumption of the component deviates from the nominal power signature.

2. The computer-implemented method of claim 1, further comprising:
determining that communications with the component have not been lost, and
determining that failure of the component is impending based on the determination that power consumption of the component deviates from the nominal power signature and the determination that communications with the component have not been lost.

3. The computer-implemented method of claim 2, wherein the executing corrective action comprises generating a notification requesting preventative maintenance for the component.

4. The computer-implemented method of claim 1, further comprising:
determining that communications with the component have been lost, and
determining that the component has failed based on the determination that power consumption of the component deviates from the nominal power signature and the determination that communications with the component have been lost.

5. The computer-implemented method of claim 4, wherein the component is a sensor on the vehicle.

6. The computer-implemented method of claim 5, wherein the executing corrective action comprises causing information from the sensor to be disregarded based on the determination that the sensor has failed.

7. The computer-implemented method of claim 1, further comprising:
receiving power consumption information for a second component in the vehicle indicative of power consumption by the second component;
comparing the power consumption information for the second component with a second nominal power signature associated with the second component; and
determining that power consumption of the second component does not deviate from the second nominal power signature.

8. The computer-implemented method of claim 7, further comprising:
determining that communications with the second component have been lost, and
determining that a communications system on the vehicle has a fault based on the determination that power consumption of the second component does not deviate from the second nominal power signature and the determination that communications with the second component have been lost.

9. The computer-implemented method of claim 1, wherein the component is associated with a plurality of nominal power signatures, and each nominal power signature of the plurality of nominal power signatures is associated with a respective operating state of the component.

10. The computer-implemented method of claim 9, wherein
the comparing the power consumption information with a nominal power signature associated with the component comprises comparing the power consumption information with a first nominal power signature of the plurality of nominal power signatures, wherein the first nominal power signature is selected from the plurality of nominal power signatures based on a current operating state of the component; and
the determining that power consumption of the component deviates from the nominal power signature comprises determining that power consumption of the component deviates from the first nominal power signature.

11. A system comprising:
at least one processor; and
a memory storing instructions that, when executed by the at least one processor, cause the system to perform:
receiving power consumption information for a component in a vehicle indicative of power consumption by the component;
comparing the power consumption information with a nominal power signature associated with the component;
determining that power consumption of the component deviates from the nominal power signature; and
executing corrective action based on the determining that power consumption of the component deviates from the nominal power signature.

12. The system of claim 11, wherein the instructions, when executed by the at least one processor, further cause the system to perform:
determining that communications with the component have not been lost, and
determining that failure of the component is impending based on the determination that power consumption of the component deviates from the nominal power signature and the determination that communications with the component have not been lost.

13. The system of claim 12, wherein the executing corrective action comprises generating a notification requesting preventative maintenance for the component.

14. The system of claim 11, wherein the instructions, when executed by the at least one processor, further cause the system to perform
determining that communications with the component have been lost, and
determining that the component has failed based on the determination that power consumption of the component deviates from the nominal power signature and the determination that communications with the component have been lost.

15. The system of claim 11, wherein the component is a sensor on the vehicle, and the executing corrective action comprises causing information from the sensor to be disregarded based on the determination that the sensor has failed.

16. A non-transitory computer-readable storage medium including instructions that, when executed by at least one processor of a computing system, cause the computing system to perform a method comprising:
receiving power consumption information for a component in a vehicle indicative of power consumption by the component;
comparing the power consumption information with a nominal power signature associated with the component;
determining that power consumption of the component deviates from the nominal power signature; and
executing corrective action based on the determining that power consumption of the component deviates from the nominal power signature.

17. The non-transitory computer-readable storage medium of claim 16, wherein the instructions, when executed by the at least one processor of the computing system, further cause the computing system to perform:
determining that communications with the component have not been lost, and
determining that failure of the component is impending based on the determination that power consumption of the component deviates from the nominal power signature and the determination that communications with the component have not been lost

18. The non-transitory computer-readable storage medium of claim 18, wherein the executing corrective action comprises generating a notification requesting preventative maintenance for the component.

19. The non-transitory computer-readable storage medium of claim 16, wherein the instructions, when executed by the at least one processor of the computing system, further cause the computing system to perform:
determining that communications with the component have been lost, and
determining that the component has failed based on the determination that power consumption of the component deviates from the nominal power signature and the determination that communications with the component have been lost.

20. The non-transitory computer-readable storage medium of claim 16, wherein the component is a sensor on the vehicle, and the executing corrective action comprises causing information from the sensor to be disregarded based on the determination that the sensor has failed.
